(19) United States
(12) Patent Application Publication
(10) Pub. No.: US 2015/0183323 A1
(43) Pub. Date: Jul. 2, 2015

(54) ON-BOARD ELECTRICAL APPARATUS

(71) Applicant: Funai Electric Co., Ltd., Osaka (JP)

(72) Inventor: Shinya HATANO, Nara-shi (JP)

(21) Appl. No.: 14/574,833

(22) Filed: Dec. 18, 2014

(30) Foreign Application Priority Data
Dec. 26, 2013 (JP) 2013-268212

(51) Int. Cl. B60K 37/04; H05K 7/02; B60K 37/02

(52) U.S. Cl. CPC B60K 37/04; B60K 37/02; H05K 7/02

(57) ABSTRACT

An on-board electrical apparatus that is to be at least partially secured to a vehicle includes a main body configured to be secured to the vehicle, and a flat sheet configured to be attachable to or detachable from the main body and to define a portion of a front surface of the main body. The sheet is a member that decorates an operation receiving section provided in the main body on the front surface and the operation receiving section is configured to receive an external operation.

### BACKGROUND OF THE INVENTION

1. Field of the Invention

The present invention relates to an on-board electrical apparatus.

2. Description of the Related Art

Navigation systems, audiovisual (AV) players, and other devices that have such functions as well as a TV broadcast receiving function, an AV recording function and the like are known as on-board electrical apparatuses.

Some on-board electrical apparatuses are equipped with anti-theft configurations. In one known anti-theft configuration, the front panel (face plate) with operational buttons and the like can be detached from the main body secured to a vehicle (e.g., see JP 6-318042 A).

The relatively large size of the above-mentioned front panel degrades its portability. Accordingly, it is inconvenient for a user to carry the front panel detached from the main body. Furthermore, if the front panel contains a board, electronic components and other precision devices, careful measures need to be taken in order to protect them against damage. Specific examples include: an anti-drop mechanism that prevents the front panel from falling when it is detached, and a protective case or bag dedicated to carry it. Using such protection measures, however, results in an undesirable increase in the number of components, incurring additional cost.

### SUMMARY OF THE INVENTION

Preferred embodiments of the present invention provide an on-board electrical apparatus that improves portability of a detachable anti-theft component and decreases the number of required components, thus reducing the overall cost.

According to an aspect of various preferred embodiments of the present invention, an on-board electrical apparatus that is to be at least partially secured to a vehicle includes a main body configured to be secured to the vehicle; and a flat sheet configured to be attachable to or detachable from the main body and to define a portion of a front surface of the main body.

With the above configuration, the on-board electrical apparatus is capable of being carried extremely easily by a user. This is because when the user leaves the vehicle, he/she needs only detach the flat sheet that has defined a portion of the front surface of the main body from the main body and carry it. Furthermore, since the sheet is not a precision device containing a board and electronic components which should be detached and carried with great care, no additional components that have been conventionally used, such as an anti-drop mechanism and a dedicated protective case or bag, are necessary. Consequently, the overall cost is significantly reduced.

According to another aspect of various preferred embodiments of the present invention, the sheet preferably is a member that decorates an operation receiving section provided in the main body on the front surface, and the operation receiving section is configured to receive an external operation.

With the above configuration, the anti-theft effect of the on-board electrical apparatus is further enhanced. This is because when the sheet is detached from the front surface of the main body, components that constitute the operation receiving section are exposed to the outside, and the appearance of the on-board electrical apparatus is therefore deteriorated.

According to further another aspect of various preferred embodiments of the present invention, when sensing presence of the sheet, the main body preferably is activated.

With the above configuration, the anti-theft effect of the on-board electrical apparatus is further enhanced. This is because when the main body senses the presence of the sheet, it is activated. Thus, the main body preferably is not activated as long as the sheet is detached.

According to still another aspect of various preferred embodiments of the present invention, identification information preferably is printed or described on the sheet, identification information being unique to each individual sheet, and the main body preferably reads the identification information from the attached sheet. When the read identification information matches identification information registered in advance, the main body preferably is activated.

With the above configuration, stealing or improper use of the on-board electrical apparatus is reliably prevented. This is because the main body attempts to verify the sheet on the basis of the identification information printed or described thereon which is unique to each individual sheet, and when the verification is conducted successfully, the main body is activated.

According to yet another aspect of various preferred embodiments of the present invention, the sheet preferably includes a plurality of removable parts that are configured to be able to alter a shape of the sheet by being separated from the sheet. In addition, the main body preferably senses the shape of the attached sheet, and when the sensed shape matches a shape of a sheet which has been registered in advance, the main body preferably is activated.

With the above configuration, stealing or improper use of the on-board electrical apparatus is reliably prevented. This is because the main body attempts to verify the sheet on the basis of its shape, and when the verification is conducted successfully, the main body is activated.

The technical ideas of various preferred embodiments of the present invention may be implemented using any product other than the above on-board electrical apparatus or any method. For example, the above main body and sheet may be regarded as respective independent inventions. Moreover, processing performed by an on-board electrical apparatus may be regarded as a method invention. In addition, a program for use in causing an on-board electrical apparatus to perform an operation or processing as described above and a computer-readable medium that stores this program may also be regarded as respective independent inventions.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 illustrates a perspective view of an on-board electrical apparatus according to a first preferred embodiment of the present invention.

FIG. 2 illustrates an exploded, perspective view of the on-board electrical apparatus.

FIG. 3 illustrates a partial cross section of the on-board electrical apparatus.

FIG. 4 illustrates an exemplary circuit configuration of the sheet sensing section.

FIG. 5 illustrates a perspective view of an on-board electrical apparatus according to a second preferred embodiment of the present invention.

FIG. 6 illustrates an exemplary configuration of a sheet sensing section according to a third preferred embodiment of the present invention.

FIG. 7 illustrates a flowchart of processing according to the third preferred embodiment of the present invention.

FIG. 8 illustrates an exemplary sheet according to a fourth preferred embodiment of the present invention.

FIG. 9 illustrates a flowchart of processing according to the fourth preferred embodiment of the present invention.

### DETAILED DESCRIPTION OF THE PREFERRED EMBODIMENTS

Some preferred embodiments of the present invention will be described below with reference to the drawings.

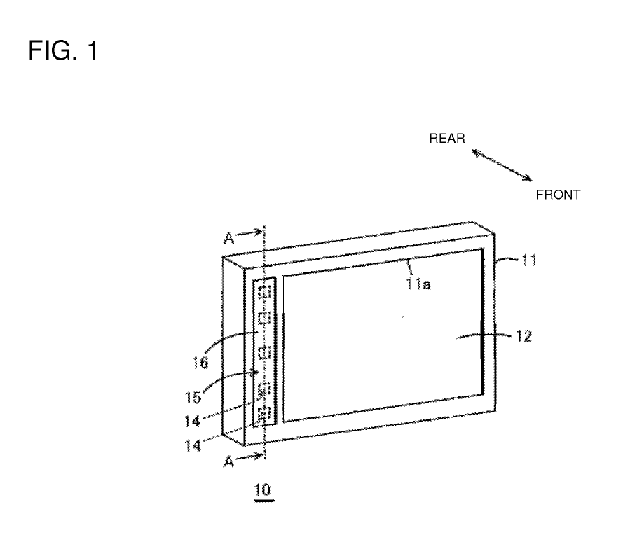

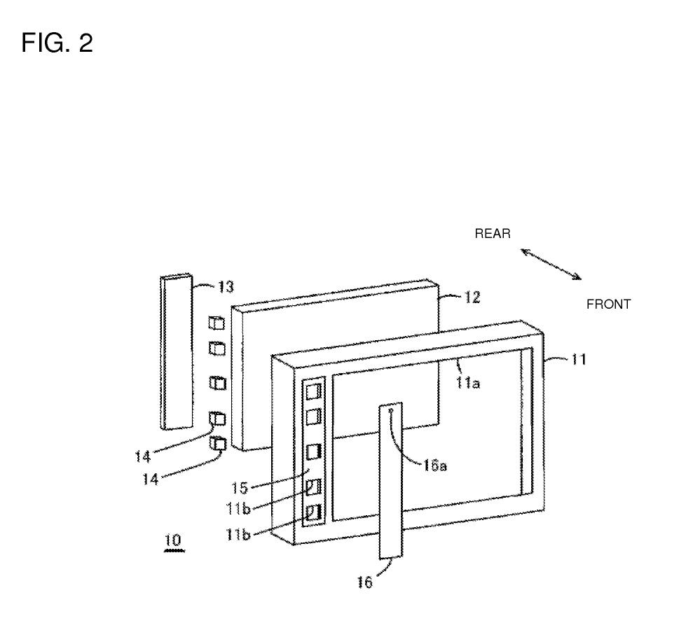

FIG. 1 schematically illustrates a perspective view of an on-board electrical apparatus 10 according to a first preferred embodiment of the present invention, and FIG. 2 schematically illustrates an exploded, perspective view of the on-board electrical apparatus 10. The on-board electrical apparatus 10 preferably defines and serves as a navigation system, an AV player, or some other device that has such functions as well as a TV broadcast receiving function, an AV recording function and the like. The on-board electrical apparatus 10 is a single product that preferably includes a frame-shaped housing 11; a monitor 12; a circuit board 13 provided on the rear of the monitor 12; and other non-illustrated sheet metal parts. The monitor 12 is implemented, for example, using a display panel such as a liquid crystal display. The circuit board 13 is equipped with, on its surfaces, an IC (Integrated Circuit) 13a, which will be described below, and other electronic components that are required to operate the on-board electrical apparatus 10. In general, the on-board electrical apparatus 10 configured above is fixed in a vehicle at a preset site (within a region in which a user sitting on the driver seat is capable of manually operating the on-board electrical apparatus 10).

The housing 11 includes a first aperture 11a and a plurality of second apertures 11b. The screen of the monitor 12 is exposed to the outside through the first aperture 11a; a plurality of button components 14, an infra-red receiving section, and the like are exposed to the outside through the second apertures 11b. Further, each second aperture 11b is smaller in size than the first aperture 11a. The button components 14 are present between the circuit board 13 and the corresponding second apertures 11b. The circuit board 13 performs a process in accordance with a user's instruction by sensing the depression of a given button component 14.

A flat sheet 16 is attached to the housing 11 within a predetermined area (operation area 15) in which the second apertures 11b are arrayed so as to cover them from the front of the on-board electrical apparatus 10. With the exception of at least the sheet 16, the configuration of the on-board electrical apparatus 10 corresponds to a “main body.” The sheet 16 defines a portion of the front surface of the main body when being attached to the main body, and is detachable from the main body. The sheet 16 is a sheet member, for example, made of a resin or a metal, and its long side extends in the array direction of the second apertures 11b (in the extending direction of the operation area 15 or in the vertical direction with respect to the on-board electrical apparatus 10 in the example of FIGS. 1, 2 and so on). The sheet 16 preferably has, for example, a polygonal shape or a partially or entirely curved shape in addition to a rectangular or substantially rectangular shape as illustrated in FIG. 2.

The front surface of the sheet 16 (which can be viewed by a user when being attached to the main body) preferably is equipped with appropriate designs (e.g., “menu,” “reproduce,” “forward,” and “back”) that show the presence of the button components 14 (the functions of the button components 14), for example, at the sites of the corresponding second apertures 11b. A user can press down indirectly the button components 14 by pushing the sites of the corresponding designs on the front surface of the sheet 16. Accordingly, the sheet 16 is a member that decorates an operation receiving section (e.g., the operation area 15 and the button components 14) in the main body on its front surface; the operation receiving section receives an external operation of the on-board electrical apparatus 10. It should be noted that the sheet 16 may be provided outside the operation area 15, provided that it defines a portion of the front surface of the main body.

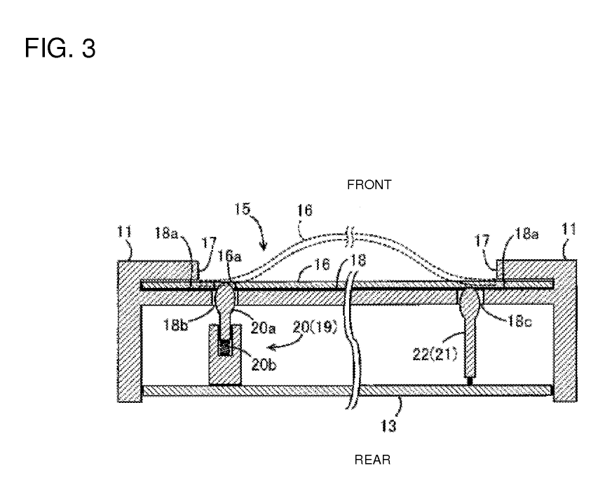

FIG. 3 illustrates a cross section taken along an A-A line in FIG. 1. In particular, FIG. 3 illustrates the regions of the on-board electrical apparatus 10 in which both longitudinal ends of the sheet 16 mate with the housing 11. In FIG. 3, the monitor 12, the button components 14, the second aperture 11b and the like are not illustrated. It can be seen from FIG. 3 that the operation area 15 includes a recess 17 when viewed from the front, and a bottom surface 18 of the recess 17 (across which the second apertures 11b are formed) is covered by the sheet 16. The operation area 15 is provided with notches (slits 18a) at its longitudinal ends; both slits 18a continue to the bottom surface 18.

The sheet 16 is preferably made of, for example, a resin as described above, and is a member that can be bent easily by a user's fingers. Accordingly, both ends of the sheet 16 are positioned in the slits 18a while the sheet 16 is being bent (see the sheet 16 denoted by a chain line in FIG. 3), and then both ends of the sheet 16 are inserted into the slits 18a. In this way, the sheet 16 is attached easily to the operation area 15 (see the sheet 16 denoted by a solid line in FIG. 3). When the sheet 16 is detached from the operation area 15, it needs only be bent until both ends of the sheet 16 have come out of the slits 18a.

The on-board electrical apparatus 10 preferably includes a positioning section 19 that positions the attached sheet 16 to the extent that it is not detached easily. In FIG. 3, a projection 20 is illustrated as an example of the positioning section 19. The projection 20 is provided close to at least one of the slits 18a, and includes a projecting piece 20a and a biasing member 20b. Specifically, the projecting piece 20a partially projects from the bottom surface 18 through a hole 18b provided therein; the biasing member 20b, for example, made of a spring, urges the projecting piece 20a toward the front. The sheet 16 includes a hole 16a (see also FIG. 2) provided therein into which the projecting piece 20a will fit. Specifically, when the sheet 16 is attached, the projecting piece 20a is temporarily retracted by being pressed by the sheet 16. Then, when both longitudinal ends of the sheet 16 are inserted into the slits 18a, the projecting piece 20a fits into the hole 16a of the sheet 16, and consequently the sheet 16 becomes flat. This is how the sheet 16 is positioned.

A specific configuration of the positioning section 19 is not limited to the above. Alternatively, to give an example, projections that protrude toward the front or rear may be provided at one or both of the longitudinal ends of the sheet 16, and these projections preferably mate with the slits 18a, so that the sheet 16 attached to the operation area 15 is positioned. To give another example, each slit 18a may be configured such that its inner space is narrowed toward the depth. When the ends of the sheet 16 are inserted into the slits 18a, the ends may be held at midway points of the slits 18a, so that the sheet 16 is positioned.

The on-board electrical apparatus 10 preferably is provided with a sheet sensing section 21, which is used to activate the on-board electrical apparatus 10 when sensing the presence of the sheet 16. In FIG. 3, a switch section 22 is illustrated as a configuration of a portion of the sheet sensing section 21. The switch section 22 is provided close to at least one of the slits 18a, and preferably protrudes from the bottom surface 18 through a hole 18c provided therein. In addition, the switch section 22 is urged toward the front by a non-illustrated biasing member such as a spring. With this configuration, when the sheet 16 is not present, the switch section 22 is disposed at a first location with its end partially protruding from the bottom surface 18 through the hole 18c. When the sheet 16 is present, the end of the switch section 22 is pressed by the sheet 16, and the switch section 22 is thereby disposed at a second location, which is more inward than the first location. In FIG. 3, the switch section 22 present at the second location is illustrated.

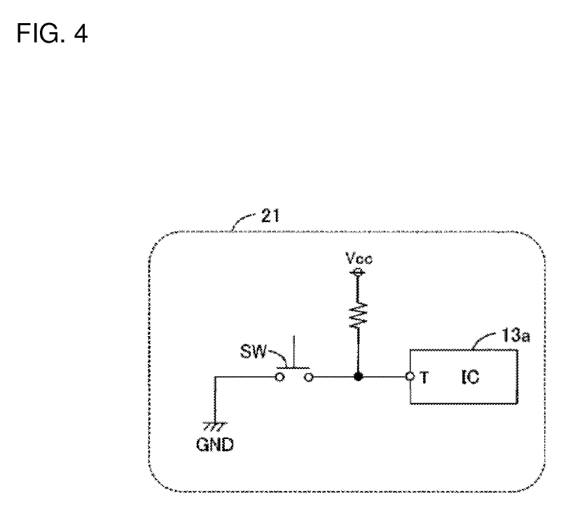

FIG. 4 illustrates an exemplary circuit configuration of the sheet sensing section 21. The IC 13a is mounted on the circuit board 13, and controls the operation (e.g., the output of sound or video) of the on-board electrical apparatus 10 in accordance with a predetermined program. In addition, the IC 13a senses, for example, the depression of each button component 14 (not illustrated in FIG. 4). The IC 13a includes a sheet sensing port T. For example, the port T is kept being pulled up by a preset source voltage Vcc. A switch terminal SW is disposed between the port T and the ground GND. The switch terminal SW defines and serves as a portion of the switch section 22. When the switch section 22 is disposed at the first location, the switch terminal SW is set to an OFF state, causing the port T to be disconnected from the ground GND. When the switch section 22 is disposed at the second location, the switch terminal SW is set to an ON state, causing the port T to be connected to the ground GND.

When the sheet 16 is attached to the operation area 15 and the switch section 22 is thus moved from the first location to the second location, the IC 13a senses that the potential at the port T is decreased to the ground GND. On the basis of this sensing result, the IC 13a senses the presence of the sheet 16. When sensing the presence of the sheet 16, the IC 13a starts supplying electricity to individual sections (e.g., an audio processing circuit that outputs sound, a video processing circuit that outputs images, and the monitor 12) in the on-board electrical apparatus 10, thus activating them. While the engine in the vehicle equipped with the on-board electrical apparatus 10 is turned ON, the source voltage is being applied to the IC 13a through another voltage application route (not illustrated). However, unless sensing the presence of the sheet 16 through the port T, the IC 13a does not activate the sections in the on-board electrical apparatus 10, namely, keeps the on-board electrical apparatus 10 in a sleep state. In this sleep state, the IC 13a accepts no operations using the button components 14.

According to the preferred embodiment described above, when a user of the on-board electrical apparatus 10 leaves a vehicle, he/she can detach the sheet 16 easily from the main body of the on-board electrical apparatus 10 and carry it. Because the sheet 16 preferably is in the form of a flat card, for example, made of a resin, it is much smaller and thinner than any other conventional detachable front panel (face plates) or the like. Therefore, the user can carry the sheet 16 extremely easily, for example, by putting it in his/her wallet or card holder (train pass holder, etc.). Moreover, the sheet 16 is not a precision device containing a board and electronic components which should be detached and carried with great care. This configuration therefore requires no additional components that have been conventionally used, such as an anti-drop mechanism and a dedicated protective case or bag, thus being able to decrease the overall cost.

While the sheet 16 is separated from the front surface of the main body in the on-board electrical apparatus 10, the second apertures 11b and the button components 14 are exposed to the outside, in which case the appearance of the on-board electrical apparatus 10 is deteriorated. Thus, detaching the sheet 16 in this manner makes it possible to enhance the anti-theft effect of the on-board electrical apparatus 10. Furthermore, the on-board electrical apparatus 10 in this preferred embodiment is provided with the sheet sensing section 21, and when the sheet sensing section 21 senses the presence of the sheet 16, the on-board electrical apparatus 10 is activated. Therefore, as long as the sheet 16 is separated, the on-board electrical apparatus 10 is not activated. This configuration also makes it possible to enhance the anti-theft effect.

Next, other preferred embodiments will be described below. It should be noted that some or all of the preferred embodiments can be combined as appropriate and performed, and matters described in one preferred embodiment can also be used in another preferred embodiment as appropriate.

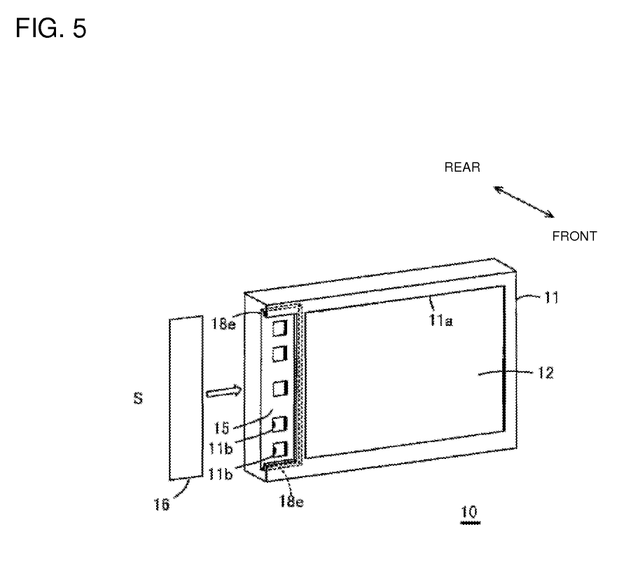

FIG. 5 illustrates a perspective view of an exemplary on-board electrical apparatus 10 according to a second preferred embodiment of the present invention. The second preferred embodiment differs from the first preferred embodiment described above in a shape of an attachment of an on-board electrical apparatus 10 to a sheet 16; otherwise they are preferably the same as each other. The sheet 16 is made of, for example, a metal as described above. Metal sheets are more resistant to bending than resin sheets. In this case, as illustrated in FIG. 5, when the sheet 16 is attached to an operation area 15, it is preferably made to slide over the on-board electrical apparatus 10 from a side S while being maintained in the flat shape. A slit 18e preferably has a U-shaped or substantially U-shaped configuration around the periphery of the operation area 15. The groove of the slit 18e which has a U-shaped or substantially U-shaped configuration is opened on the side S. When the sheet 16 is inserted into the slit 18e from the side S, three sides of the sheet 16 mate with the slit 18e. As a result, the sheet 16 defines a portion of the front surface of the main body in the on-board electrical apparatus 10. In order to detach the sheet from the on-board electrical apparatus 10, it is only necessary to pull the sheet 16 on the side S. According to the second preferred embodiment described above, it is also possible to attach/detach the sheet 16 extremely easily to or from the on-board electrical apparatus 10 and carry it.

A sheet sensing section 21 may sense not only the presence of a sheet 16 but also normality of an existing sheet 16. More specifically, pieces of identification information preferably are printed or described on sheets 16, such that they uniquely correspond to the individual sheets 16. Then, a main body (the sheet sensing section 21 in an on-board electrical apparatus 10) reads the identification information from the attached sheet 16. If the read identification information matches identification information registered in advance, the main body regards the existing sheet 16 as being normal, and then activates the on-board electrical apparatus 10.

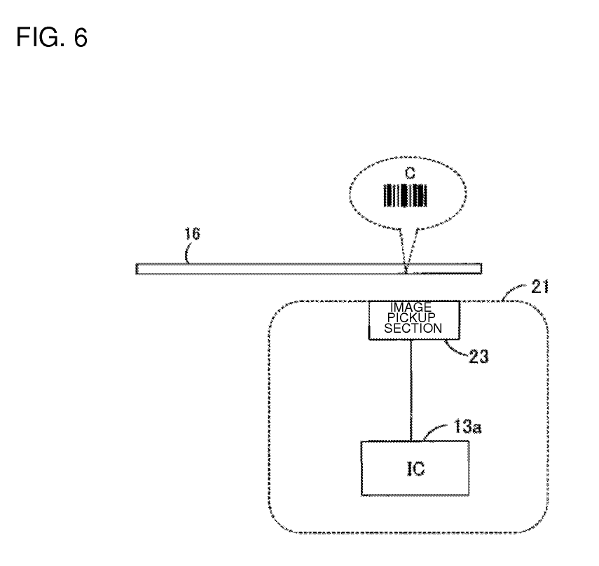

FIG. 6 illustrates an exemplary configuration of a sheet sensing section 21 according to a third preferred embodiment of the present invention. The sheet sensing section 21 includes an image pickup section 23. The image pickup section is disposed within a housing 11 in the rear of a bottom surface 18 of an operation area 15. The image pickup section 23 includes a sensor configured to optically read a target object to be read. When the sheet 16 is attached to the on-board electrical apparatus 10 as described above, the image pickup section 23 optically reads identification information C printed or described on the rear surface of the sheet 16. The identification information C is unique information regarding a single sheet 16 that is to be paired with a single on-board electrical apparatus 10, and is preferably defined by a one-dimensional code (bar code), a two-dimensional code, a character string or the like. Alternatively, a region in which a user is permitted to handwrite arbitrary characters or letters may be defined on the rear surface of the sheet 16, and characters or letters written in this region may be used as the identification information C. The bottom surface 18 is provided with a predetermined hole that defines the space between the image pickup section 23 and a preset region on the rear surface of the sheet 16 in which the identification information C is printed or written. With this hole, the identification information C in the rear surface of the sheet 16 is arranged to be read by the image pickup section 23 without inhibition.

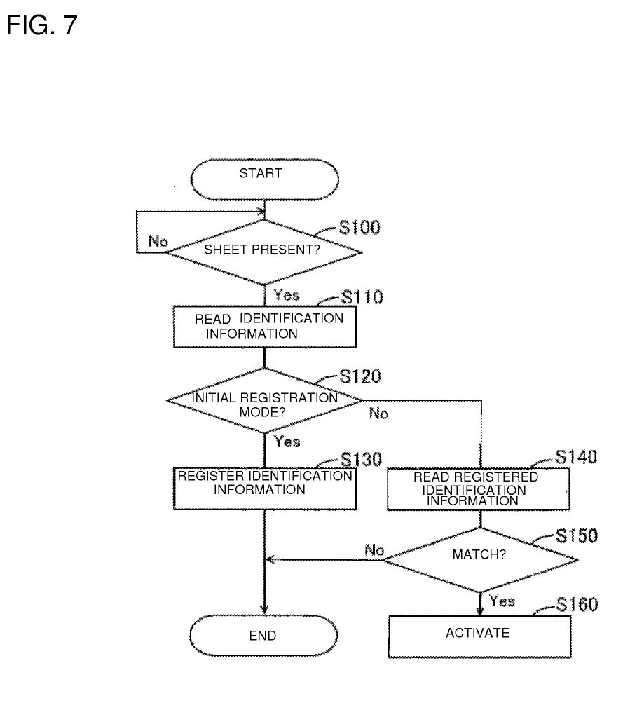

FIG. 7 illustrates a flowchart of processing according to the third preferred embodiment which is performed by the IC 13a. At Step S100, the IC 13a repeatedly decides whether the sheet 16 is present or not. If the IC 13a decides that the sheet 16 is present, the processing proceeds to Step S110. For example, the decision at Step S100 may be made by the method described with reference to FIGS. 3 and 4.

At Step S110, the IC 13a causes the image pickup section 23 to read the identification information C. Then, the IC 13a receives, from the image pickup section 23, data concerning the result of reading the identification information C with the image pickup section 23.

At Step S120, the IC 13a decides whether or not a currently indicated mode is an initial registration mode. The initial registration mode refers to a mode in which a user gives an instruction to the on-board electrical apparatus 10 through the operation using the button components 14 and the like while the sheet 16 is attached to the operation area 15, in order to register the identification information C in the on-board electrical apparatus 10. If the initial registration mode is currently indicated, the IC 13a makes the processing proceed to Step S130. If the initial registration mode is not currently indicated, the IC 13a makes the processing proceed to Step S140.

At Step S130, the IC 13a registers unique information indicated by the data received from the image pickup section 23 at Step S110, after which the IC 13a terminates the processing in this flowchart. If the identification information C is a one-dimensional or two-dimensional code, the IC 13a analyzes this code, and extracts a unique character string from the code. Then, the IC 13a registers the extracted character string (stores it in a predetermined memory) as the identification information. If the identification information C is (printed or described) letters or characters, the IC 13a analyzes the data concerning an image received from the image pickup section 23. Then, the IC 13a identifies the letters or characters, for example, through a letter or shape recognition technique, and registers them as the identification information.

At Step S140, the IC 13a reads the identification information (registered identification information) that has been registered at Step S130 in the initial registration mode, from the memory.

At Step S150, the IC 13a compares the read, registered identification information with the unique information indicated by the data received from the image pickup section 23 at Step S110. The IC 13a thereby decides whether both pieces of information match each other or not. If they do not match, the IC 13a regards the attached sheet 16 as not being normal, after which it terminates the processing of the flowchart. If they match, the IC 13a makes the processing proceed to Step S160, and then starts supplying electricity to the individual sections in the on-board electrical apparatus 10, activating them. As a result, the on-board electrical apparatus 10 operates. According to the third preferred embodiment described above, the on-board electrical apparatus 10 attempts to verify the sheet 16 by using the identification information C printed or described on the rear surface of the sheet 16. Then, when deciding that the sheet 16 is normal, the on-board electrical apparatus 10 is activated. In this way, stealing or improper use of the on-board electrical apparatus 10 is reliably prevented.

According to a fourth preferred embodiment of the present invention, a sheet sensing section 21 may sense not only the presence of a sheet 16 but also normality of an existing sheet 16. More specifically, the sheet 16 preferably includes a plurality of removable parts 16b that can alter the shape of the sheet 16 by being separated therefrom. A main body (the sheet sensing section 21 in an on-board electrical apparatus 10) senses the shape of the attached sheet 16. Then, if the sensed shape matches the shape of the sheet 16 which has been registered in advance, the main body regards the sheet 16 as being normal, and activates the on-board electrical apparatus 10.

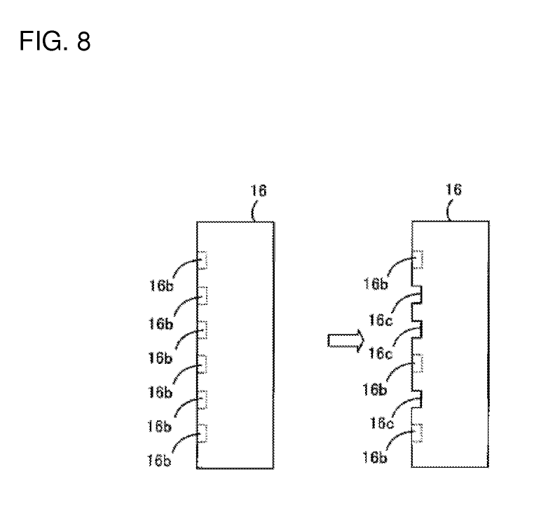

FIG. 8 illustrates an exemplary sheet 16 according to the fourth preferred embodiment of the present invention. As illustrated in the left portion of FIG. 8, the plurality of removable parts 16b are provided on one side of the sheet 16. Each removable part 16b is preferably formed by zoning a portion of the sheet 16, for example, with perforations, which enables a user to cut it out easily from the sheet 16 with his/her hand or a tool. In the right portion of FIG. 8, an exemplary sheet 16 from which some removable parts 16b have been cut out arbitrarily by a user is illustrated. The portions of the sheet 16 from which the removable parts 16b have been cut out become notches 16c.

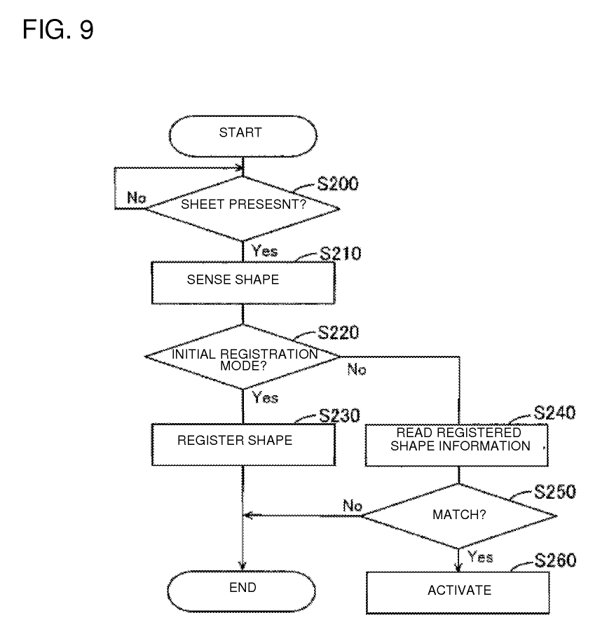

FIG. 9 illustrates a flowchart of processing according to the fourth preferred embodiment of the present invention which is performed by an IC 13a. At Step S200, the IC 13a repeatedly decides whether the sheet 16 is present or not. If the IC 13a decides that the sheet 16 is present, the processing proceeds to Step S210. For example, the decision at Step S200 may be made by the method described with reference to FIGS. 3 and 4. In this processing, it is assumed that a user arbitrarily cuts out one or more removable parts 16b from the sheet 16 to be attached to an on-board electrical apparatus 10, and the sheet accordingly has a shape with one or more notches 16c, for example, as illustrated in the right portion of FIG. 8.

At Step S210, the IC 13a causes an image pickup section 23 (see FIG. 6) to sense the shape of the sheet 16 (the shape of one side of the sheet 16). Then, the IC 13a receives data concerning the reading result of the image pickup section 23 therefrom. It should be noted that the image pickup section 23 according to the fourth preferred embodiment of the present invention is preferably configured to be movable with a motor or shaft (not illustrated), because it needs to capture an image of the entire side of the sheet 16 on which the removable parts 16b or notches 16c would be present. Furthermore, in order for the image pickup section 23 to capture an image of the side of the sheet 16, the bottom surface 18 preferably is provided with a predetermined long hole formed along the side of the bottom surface 18. With this hole, the space is ensured between the side of the sheet 16 and the image pickup section 23.

Similar to Step S120 described above, if the initial registration mode is indicated at Step S220, the processing proceeds to Step S230. If the initial registration mode is not indicated at Step S220, the processing proceeds to Step S240.

At Step S230, the IC 13a analyzes the data concerning the data received from the image pickup section 23 at Step S210. Then, the IC 13a registers information on the shape of the sheet (e.g., the number of notches 16c and their locations) which is acquired from this analysis. After that, the IC 13a terminates the processing of the flowchart.

At Step S240, the IC 13a reads the shape information (registered shape information) registered at Step S230 in the initial registration mode, from the memory.

At Step S250, the IC 13a compares the read, registered shape information with the shape of the sheet 16 (the number of notches 16c and their locations) indicated by the data that the IC 13a has received from the image pickup section 23 at S210, and thereby decides whether they match each other or not. If they do not match, the IC 13a regards the attached sheet 16 as not being normal, after which it terminates the processing of the flowchart. If they match, the IC 13a makes the processing proceed to Step S260, and then starts supplying electricity to the individual sections in the on-board electrical apparatus 10, activating them. As a result, the on-board electrical apparatus 10 operates. According to the fourth preferred embodiment of the present invention, a user is able to arbitrarily cut out removable parts 16b from the sheet 16, thus forming the sheet 16 into a unique shape. The on-board electrical apparatus 10 verifies this uniquely formed sheet 16, and if the on-board electrical apparatus 10 decides that the sheet 16 is normal, it is activated. In this way, stealing or improper use of the on-board electrical apparatus 10 is reliably prevented.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An on-board electrical apparatus to be at least partially secured to a vehicle, the on-board electrical apparatus comprising:
a main body configured to be secured to the vehicle; and
a flat sheet configured to be attachable to or detachable from the main body and to define a portion of a front surface of the main body.

2. The on-board electrical apparatus according to claim 1, wherein the sheet is a member that decorates an operation receiving section provided in the main body on the front surface, and the operation receiving section configured to receive an external operation.

3. The on-board electrical apparatus according to claim 1, wherein the main body is configured to be activated in response to a presence of the sheet being sensed.

4. The on-board electrical apparatus according to claim 1, wherein
identification information is printed or described on the sheet, the identification information being unique to each individual sheet; and
the main body is configured to read the identification information from the attached sheet, and when the read identification information matches identification information registered in advance, the main body is activated.

5. The on-board electrical apparatus according to claim 1, wherein
the sheet includes a plurality of removable parts configured to be able to alter a shape of the sheet by being separated from the sheet; and
the main body senses the shape of the attached sheet and when the read shape matches a sheet registered in advance, the main body is activated.

6. The on-board electrical apparatus according to claim 1, wherein the on-board electrical apparatus is one of a navigation system, an AV player, a television, and an audio recording device.

7. The on-board electrical apparatus according to claim 1, further comprising a frame-shaped housing; a monitor; and a circuit board.

8. The on-board electrical apparatus according to claim 1, wherein the housing includes a first aperture and a plurality of second apertures, a screen of the monitor is exposed to outside through the first aperture, and a plurality of buttons and an infra-red receiver are exposed to the outside through the second apertures.

9. The on-board electrical apparatus according to claim 1, wherein the flat sheet is made of a resin or a metal.

10. The on-board electrical apparatus according to claim 1, wherein the flat sheet has a shape that is one of polygonal, partially curved, completely curved, rectangular and substantially rectangular.

11. The on-board electrical apparatus according to claim 2, wherein the operation receiving section includes a recess configured such that a bottom surface of the recess is covered by the flat sheet.

12. The on-board electrical apparatus according to claim 1, wherein the operation receiving section includes notches extending to a bottom surface of a recess.

13. The on-board electrical apparatus according to claim 1, further comprising a positioning section configured to position the flat sheet.

14. The on-board electrical apparatus according to claim 13, wherein the positioning section includes a projection including a projecting piece and a biasing member configured to bias the projecting piece into a hole in the flat sheet.

15. The on-board electrical apparatus according to claim 1, further comprising a sheet sensing section configured to activate the on-board electrical apparatus when sensing a presence of the flat sheet.

16. The on-board electrical apparatus according to claim 15, wherein the sheet sensing section includes a circuit board and an integrated circuit mounted on the circuit board, and a switch section.

17. The on-board electrical apparatus according to claim 15, wherein the sheet sensing section is configured to detect a normality of the flat sheet.

18. The on-board electrical apparatus according to claim 1, wherein the operation receiving section includes a slit having a U-shaped or substantially U-shaped configuration around a periphery of the operation receiving section, and configured such that when the flat sheet is inserted into the slit, three sides of the flat sheet mate with the slit.

19. The on-board electrical apparatus according to claim 1, wherein the sheet sensing section includes an image pickup section configured to optically read identification information on a rear surface of the flat sheet.
